(19) United States
(12) Patent Application Publication
(10) Pub. No.: US 2024/0391066 A1
(43) Pub. Date: Nov. 28, 2024

(54) APPARATUS FOR TIGHTENING THREADED FASTENERS

(71) Applicant: HYTORC Division UNEX Corporation

(72) Inventors: ERIC P. JUNKERS, Mahwah, NJ (US); THOMAS F. MCLOUGHLIN, Montclair, NJ (US); XIAOXING ZHANG, Somerset, NJ (US)

(73) Assignee: HYTORC Division UNEX Corporation, Mahwah, NJ (US)

(21) Appl. No.: 18/273,750

(22) PCT Filed: Apr. 7, 2022
(86) PCT No.: PCT/US22/23905

§ 371 Date: Jul. 21, 2023

Related U.S. Application Data
(63) Continuation-in-part of application No. PCT/US22/13418, filed on Jan. 21, 2022.

(51) Int. Cl. B25B 21/00; B25F 5/00

(52) U.S. Cl. CPC B25B 21/005; B25F 5/005

(57) ABSTRACT

The present discloses an apparatus for transmitting torque and tightening or loosening threaded fasteners. The apparatus comprising a housing having a driving assembly and a cylinder assembly, a ratchet mechanism being arranged in the driving assembly which is further associated and drivable by the cylinder assembly. The cylinder assembly further comprises a piston assembly and an end cap assembly having a safety ring and a hydraulic cylinder assembly. The apparatus further comprises a hydraulic piston eject safety assembly intended to identify the failure of the apparatus owing to a material fault or overuse/fatigue. The apparatus may further comprise a leakage safety assembly configured to prevent hydraulic fluid from leaking at opening. The apparatus may further comprise a dual reaction assembly, a fastener, a socket, a driver a reaction fixture, an auto-release safety reaction pawl assembly, a quick coupler with thread lock assembly, a cycle counter assembly.

### CROSS REFERENCE TO RELATED APPLICATIONS AND PATENTS

This application either claims priority to and/or is either a divisional, continuation or continuation-in-part application of the following commonly owned and/or co-pending patent application, an entire copy of which is incorporated herein by reference: PCT Application Serial No. PCT/US22/13418, having Filing Date of 21 Jan. 2022, entitled “APPARATUS FOR TIGHTENING THREADED FASTENERS”.

### BACKGROUND

### Field of Invention

The present invention relates to power tools. More particularly, the present invention relates hydraulically driven torque apparatus with a safety mechanism for tightening or loosening threaded fasteners.

### Description of Related Art

Hydraulically powered wrenches are well-known and commonly used instruments in industry for transferring rotational power to threaded fasteners. A basic wrench design consists of a hydraulically driven, reciprocating piston within a driver in the form of a power head unit. There are a range of different types of power wrenches. Torque wrenches with hydraulic motors are commonly used for tightening large nuts on bolts or studs, as well as in narrow clearance installations where a lengthy wrench handle would be too long.

FIG. 1A depicts a partial cross-sectional view of a prior art tool 100 for tightening and loosening threaded fasteners, such as Applicant's AVANTI® square drive hydraulic tool. A driving assembly 103 (not shown), a cylinder assembly 104, and a uniswivel fluid assembly 105 are all contained within a housing 102. A ratchet is included in a known lever-type ratchet mechanism arranged in driving assembly 103, which is connected to and drivable by cylinder assembly 104.

The ratchet can be rotated around a force axis. During tool 100 operation, the ratchet is connected to a driving element, which receives a first turning force acting in one direction around the turning force axis. A deep well is turned by the first turning force. A deep well hex socket attached to the driving element is turned by the first turning force, which next turns a fastener. A piston 106, reciprocating moveable along a piston axis A100 by and linked with a piston rod 107, and an end cap assembly 108 are created within the housing 102. Miscellaneous components such as O-rings 109, seals 110, and/or retaining rings 111 are included in the cylinder assembly 104. Tool 100 can be replaced with any known fluid operated tool for tightening and loosening threaded fasteners with any known components.

A perspective view of end cap assembly 108 of cylinder assembly 104 of prior art tool 100 is shown in FIG. 1B (prior art). A typically cylindrical housing 120 defines a coaxial hydraulic cylinder (or sleeve) 121 within the end cap assembly 108. At one end of cylindrical housing 120 is an end wall (or cap) 122, and at the other end is an opening 123 that admits piston 106. When hydraulic fluid is injected by uniswivel fluid assembly 105, piston 106 drives linked piston rod 107 within sleeve 121. The cylinder assembly 104 is mounted and sealed within housing 102 by O-rings 109, seals 110, and/or retaining rings 111, which prevent hydraulic fluid from flowing out at aperture 23.

Traditional threaded fastener tightening equipment lacks adequate safety features. Hydraulic tool failure can occur owing to a material fault or overuse/fatigue, which can cause the apparatus housing to fracture further. Other components of the apparatus can disengage from, slip out of, and/or be expelled from the apparatus if the housing fractures.

Furthermore, the apparatus's components may be ejected under tremendous pressure and at high speeds, causing serious property damage and/or bodily harm. Conventional hydraulic torque apparatus of the prior art lack sufficient features to meet modern bolting demands. The present invention has therefore been devised to solve these issues.

Housing may rupture if a tool fails due to a material fault or fatigue. As a result, the end cap becomes an item that can be ejected. This could result in property damage or injury to personnel.

A simple, effective, and reliable safety apparatus is required to avoid such unforeseen effects.

### SUMMARY

In view of the foregoing disadvantages inherent in the prior art, the general purpose of the present invention is to provide an apparatus with a safety mechanism for tightening/loosening threaded fasteners, to include all advantages of the prior art, and to overcome the drawbacks inherent in the prior art.

Embodiments in accordance with the present invention provide an apparatus for transmitting torque and tightening or loosening threaded fasteners. The apparatus comprising a housing having a driving assembly and a cylinder assembly, a ratchet mechanism being arranged in the driving assembly which is further associated and drivable by the cylinder assembly. The cylinder assembly also includes a piston assembly reciprocating movable along a piston axis. The cylinder assembly further comprises an end cap assembly having a safety ring and a hydraulic cylinder assembly. The hydraulic cylinder assembly including an end cap at a first end and an opening having an adjacent internally threaded surface at a second end that accepts a piston and threadedly engages with the safety ring. The safety ring being configured to retain a piston of a hydraulically driven torque tool for tightening and/or loosening of threaded fasteners. The safety ring having an externally threaded surface. The safety ring further comprises an internal surface including a retaining lip at one end which extends inwardly. The apparatus also includes a leakage safety assembly configured to prevent hydraulic fluid from leaking at opening. The apparatus also includes a hydraulic piston eject safety assembly intended to identify the failure of the apparatus owing to a material fault or overuse/fatigue, which causes the housing to fracture, further portions of the piston assembly, end cap assembly, and/or housing are disengaged from, slip out of, and/or ejected from the apparatus when the housing fractures.

Embodiments in accordance with the present invention provide an apparatus further comprising a dual reaction assembly, a fastener, a socket, a driver a reaction fixture, an auto-release safety reaction pawl assembly, a quick coupler with thread lock assembly, a cycle counter assembly.

An object of the present invention is to introduce an entirely new level of advanced bolting technology including inline, coaxial reaction first revolutionized, the auto-release pawl assembly, new quick connect fluid couplers with thread lock assemblies, a new safety end cap assembly, a new spline cover assembly, a new cycle counter assembly and a new safety end cap assembly.

In one embodiment of the present invention, the quick-coupler with thread lock assembly has a locking mechanism to prevent accidental disconnection, eliminating the need for the operator to guess when connections are secure.

Embodiments in accordance with the present invention provide a dual-reaction feature allows easy field configuration for the rear and/or side (coaxial inline) reaction, replacing the need for two separate tools with one tool. The dual-reaction feature allows the user to configure the wrench for rear reaction arms compatible with the original or newer reaction arms compatible with one or more product lines. A new, easy to install and remove, spline cover prevents damage to the apparatus's rear reaction arm splines. The spline cover assembly is applied when using inline, coaxial drive reaction systems protect the rear splines and improve safety.

These and other advantages will be apparent from the present application of the embodiments described herein.

This together with the other aspects of the present invention, along with the various features of novelty that characterize the present disclosure, is pointed out with particularity in the claims annexed hereto and forms a part of the present invention. For a better understanding of the present invention, its operating advantages, and the specified object attained by its uses, reference should be made to the accompanying drawings and descriptive matter in which there are illustrated exemplary embodiments of the present disclosure.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1A illustrates a cross-section view of a prior art, according to embodiments of the present invention disclosed herein;

FIG. 1B illustrates a perspective view of a prior art, according to embodiments of the present invention disclosed herein;

FIG. 2A illustrates a partial cross-section view of an apparatus a safety mechanism for tightening/loosening threaded fasteners, according to embodiments of the present invention disclosed herein;

FIG. 2B illustrates a cross-section view of the apparatus, according to embodiments of the present invention disclosed herein;

FIG. 2C illustrates a perspective view of a component of the apparatus, according to embodiments of the present invention disclosed herein;

FIG. 3 illustrates a perspective view of the apparatus with a safety mechanism for tightening/loosening threaded fasteners, according to embodiments of the present invention disclosed herein;

FIG. 4 illustrates a sectional view of the apparatus with a safety mechanism for tightening/loosening threaded fasteners, according to embodiments of the present invention disclosed herein;

FIG. 5 illustrates a cross-section view of the apparatus, according to embodiments of the present invention disclosed herein;

FIG. 6 illustrates a sectional view of other components of the apparatus with a safety mechanism for tightening/loosening threaded fasteners, according to embodiments of the present invention disclosed herein;

FIG. 7 illustrates a side view of the apparatus with a safety mechanism for tightening/loosening threaded fasteners, according to embodiments of the present invention disclosed herein;

FIG. 8A-8D illustrates a sectional view of various components of the apparatus with a safety mechanism for tightening/loosening threaded fasteners, according to embodiments of the present invention disclosed herein;

FIG. 9 illustrates a perspective view of the apparatus with a safety mechanism for tightening/loosening threaded fasteners, according to embodiments of the present invention disclosed herein; and

FIG. 10-11 illustrates a sectional view of the apparatus with a safety mechanism for tightening/loosening threaded fasteners, according to embodiments of the present invention disclosed herein.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The following description includes the preferred best mode of one embodiment of the present invention. It will be clear from this description of the invention that the invention is not limited to these illustrated embodiments, but the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

The exemplary embodiments described herein detail for illustrative purposes are subject to many variations in implementation. The present disclosure provides a hydraulic driven apparatus with a safety mechanism for tightening/loosening threaded fasteners. It should be emphasized, however, that the present disclosure is not limited only to what is disclosed and extends to cover various alternation to the apparatus for tightening/loosening threaded fasteners. It is understood that various omissions and substitutions of equivalents are contemplated as circumstances may suggest or render expedient, but these are intended to cover the application or implementation without departing from the scope of the present invention.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a”, “an”, and “the” designate both the singular and the plural, unless expressly stated to designate the singular only.

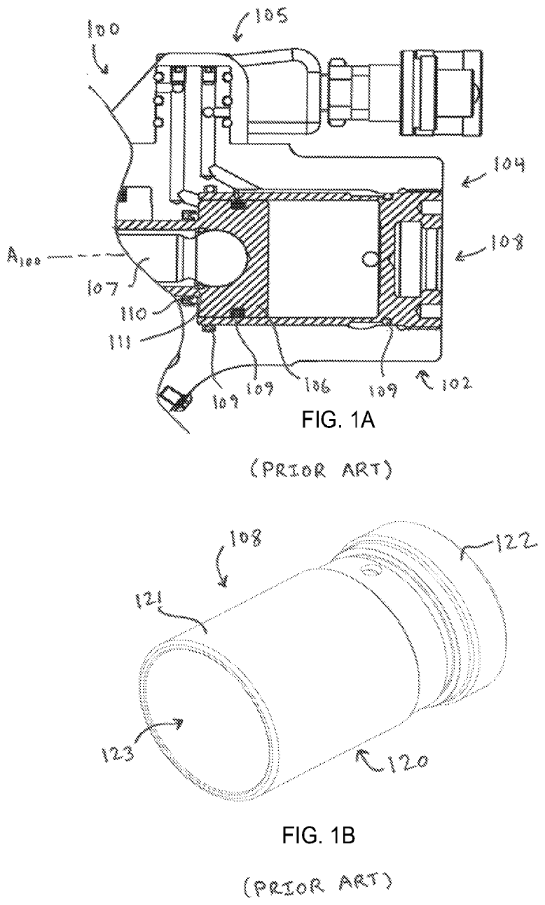

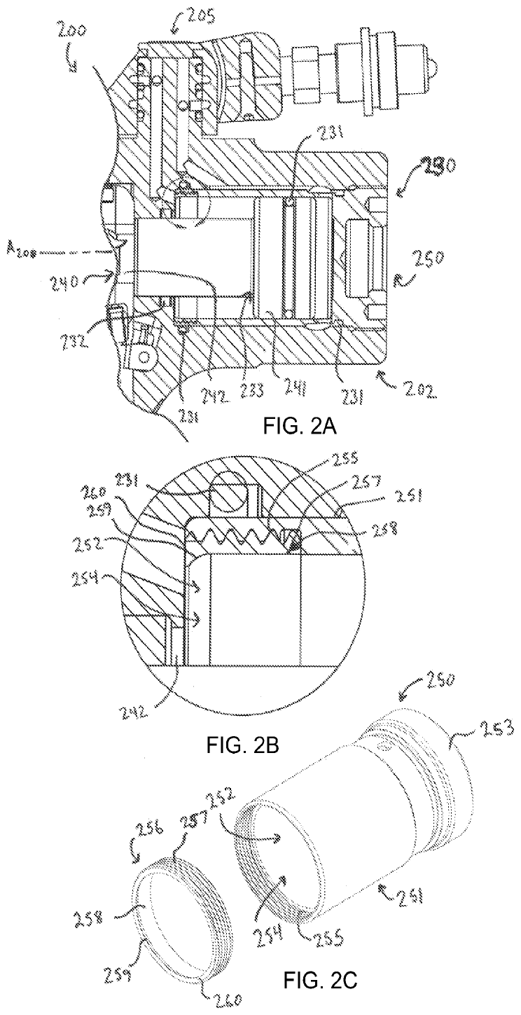

An apparatus 200 with a safety mechanism for tightening/loosening threaded fasteners will now be described in conjunction with FIGS. 2A to 11, in accordance with an exemplary embodiment of the present disclosure. FIG. 1A and FIG. 1B illustrates a prior art explained in background of the specification. Referring now to FIGS. 2A to 11, various views and components of the apparatus 200 with a safety mechanism for tightening/loosening threaded fasteners are shown. For example, FIG. 2A-2B illustrates a partial cross-section view of an apparatus 200. FIG. 2C illustrates a perspective view of a component of the apparatus 200. Further, FIG. 2A to FIG. 11, illustrates a various views and components of the apparatus, in accordance with an exemplary embodiment of the present disclosure, and will now be described in conjunction to all the FIGS. 2A to 11.

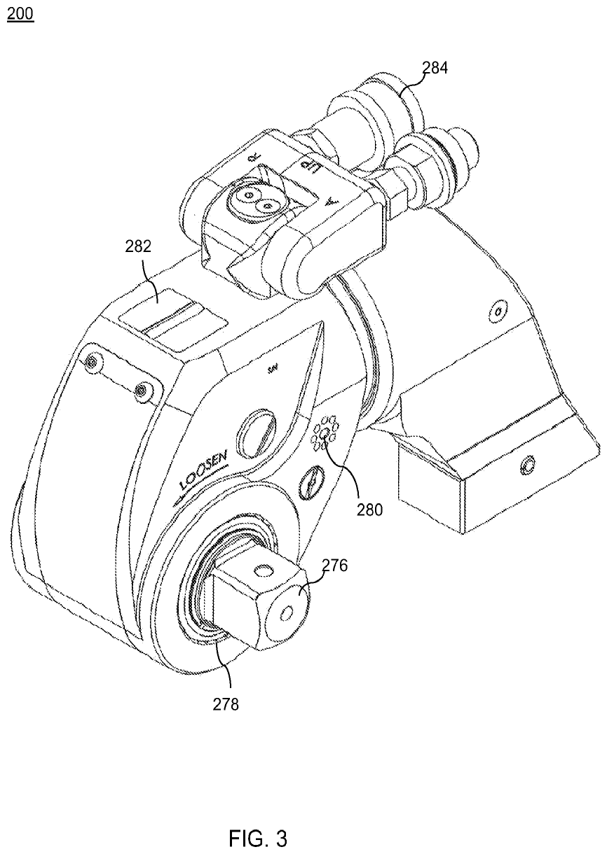

Referring to FIG. 2A, FIG. 2B, FIG. 2C and FIG. 3, the apparatus 200 comprising a housing 202 having a driving assembly 203 and a cylinder assembly 230. In an embodiment of the present invention, a ratchet mechanism that may be arranged in the driving assembly 203 which is further associated and drivable by the cylinder assembly 230.

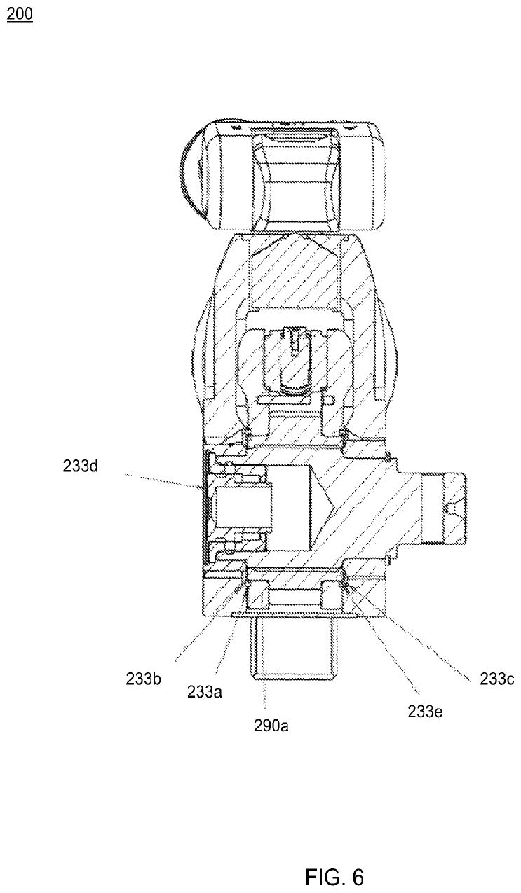

The cylinder assembly 230 may comprise a piston assembly 240 reciprocating movable along a piston axis. The piston assembly 240 has a first end formed as the piston 241 and a second end is formed as a piston rod 242 having a rod pin 242a. Referring to FIG. 6, the cylinder assembly 230 may further include a plurality of components such as, but not limited to, O-rings 231, seals 232, retaining rings 233a-233n, and/or any foregoing combination.

The cylinder assembly 230 further comprises an end cap assembly 250 having a safety ring 256 and a hydraulic cylinder assembly. The end cap assembly 250 may comprise a cylindrical housing 251 defining a coaxial hydraulic cylinder (or sleeve) 252 within. The cylindrical housing 251 has an end wall (or cap) at a first end and an opening 254 at a second end that accepts piston 241.

The hydraulic cylinder assembly may include an end cap at a first end and the opening 254 having an adjacent internally threaded surface at a second end that accepts the piston 241 and threadedly engages with the safety ring 256. The safety ring 256 may be configured to retain a piston of a hydraulically driven torque apparatus 200 for tightening and/or loosening of threaded fasteners.

The safety ring 256 may comprise an externally threaded surface. The safety ring 256 may further comprise the internal surface including a retaining lip 259 at one end which extends inwardly. In an embodiment of the present invention, the safety ring 256 may be threadedly engageable with an adjacent opening 254. The adjacent opening 254 of sleeve may be internal threads to receive external threads of the safety ring 256.

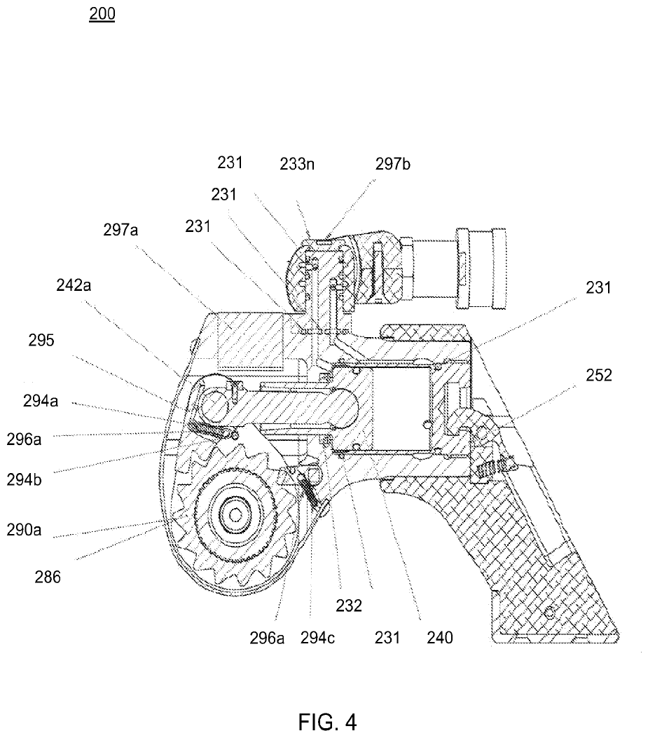

A ratchet 286 may be connected with a driving element and the ratchet 286 may be turn-able about a turning force axis, as seen particularly in FIG. 4. In an embodiment of the present invention, the ratchet 286 receives a first turning force acting about the turning force axis in one direction during operation of the apparatus 200, further the first turning force turns a deep well hex socket attached to the driving element, which turns a fastener.

In preferred embodiments of the present invention, the internal surface of the safety ring 256 may be smooth and lines up with an internal surface of sleeve 252 once assembled to allow movement of the piston 241 throughout. The internal surface including the retaining lip 259 may prevent the piston assembly 240 from being separated from the end cap assembly 250. In an exemplary embodiment of the present invention, the smooth internal surface of the safety ring 256 and a smooth internal surface of the hydraulic cylinder assembly form the sleeve 252 which allows movement of the piston 241 throughout.

Further, an outer edge 260 of the retaining lip 259 may co-terminates with opening 254 when assembled. The internally threaded surface at the second end is recessed from the smooth internal surface of the hydraulic cylinder assembly to accept the safety ring 256 such that the smooth internal surface of the safety ring 256 and the smooth internal surface of the hydraulic cylinder assembly form a sleeve 252 which allows movement of the piston 241 throughout.

The apparatus also includes a leakage safety assembly configured to prevent hydraulic fluid from leaking at opening. The leakage safety assembly may comprise the piston 241 inserted into opening 254 and sleeve 252. The leakage safety assembly may also include the safety ring 256 threaded into the sleeve 252 at the opening 254, the piston rod 242 attached to the piston 241 and the drive assembly 203, the end cap assembly 250 may be attached to the housing 202, the O-rings 231, the seals 232 and/or the retaining rings 233 mounted and sealed cylinder assembly 230 within the housing 202 to prevent hydraulic fluid from leaking at the opening 254.

The apparatus 200 may include a hydraulic piston eject safety assembly intended to identify the failure of the apparatus 200 owing to a material fault or overuse/fatigue, which causes the housing 202 to fracture, further portions of the piston assembly 240, end cap assembly 250, and/or housing 202 are disengaged from, slip out of, and/or ejected from the apparatus 200 when the housing fractures. when the apparatus 200 fails, the safety ring 256 may prevent the piston 241 from being detached from the end cap assembly 250 by drawing the piston 241 with the end cap assembly 250, and a component of the drive assembly 203 is suited to grab the piston 241, preventing and/or substantially slowing any projection thereof.

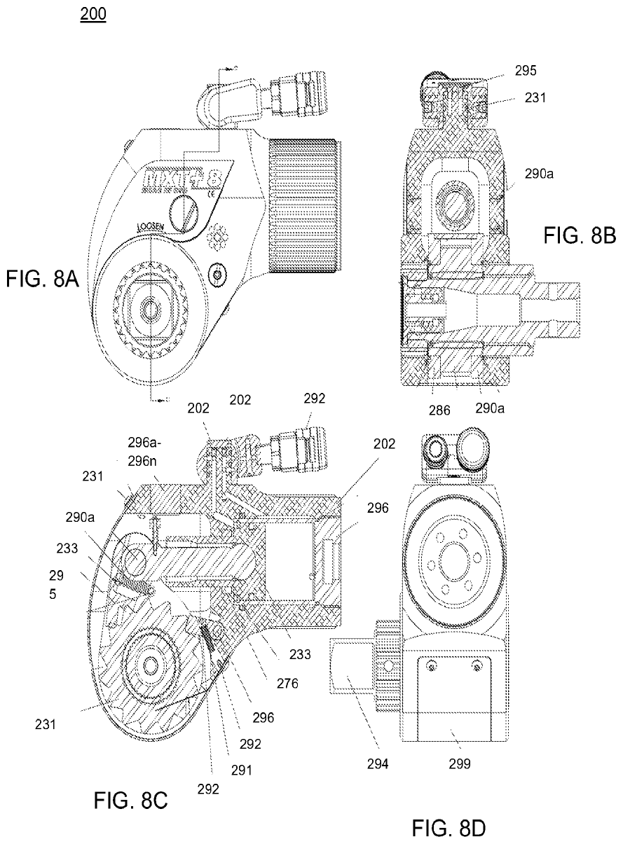

Referring to FIG. 8A to 8D, the apparatus 200 may comprise of AV01D steel 290b further comprising a dual reaction assembly, a fastener, a socket 301, a driver a reaction fixture, an auto-release safety reaction pawl assembly 288, a quick coupler with thread lock assembly, a cycle counter assembly, a drive plate left 290a, an access plug 291, a BHCS 292, FHCS 299, a plurality of retainers 233a-233n.

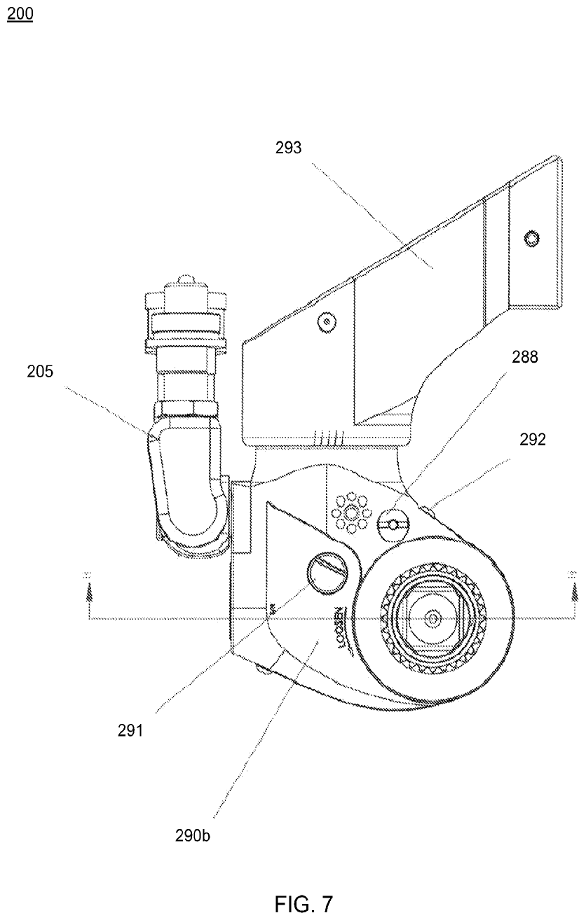

Referring to FIG. 7, the dual reaction assembly may be configured to allow the user to configure the apparatus 200 for rear reaction arms 293 compatible with the original or newer reaction arms 293. The dual-reaction feature simplifies field configuration for rear and/or side (coaxial inline) reactions, eliminating the need for two separate apparatus.

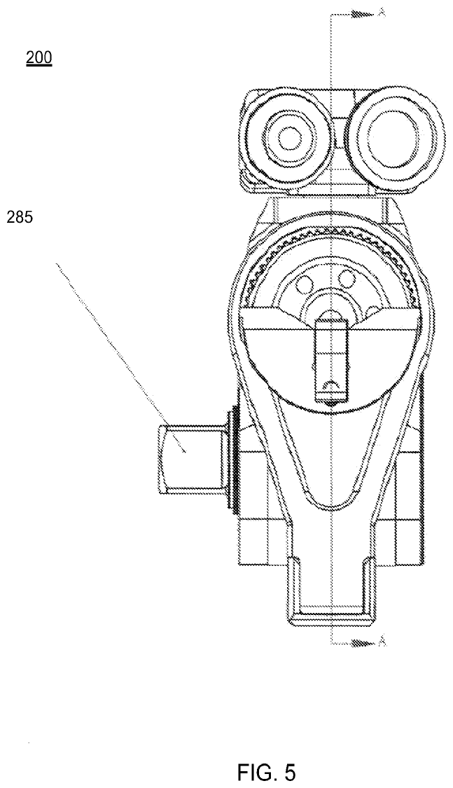

The dual-reaction feature may allow the operator to set up the apparatus with rear reaction arms 293 that are interchangeable with other reaction arms 293. The rear splines of the apparatus 200 are protected by a new spline cover that is simple to install and remove. When using inline, coaxial drive reaction systems, the spline cover assembly is used to shield the rear splines and improve safety. Further, the apparatus may comprise a dual SQ drive 285 as shown in FIG. 5, a plurality of pins 294a-294c, an outer button 300 and an inner button 303.

In an embodiment of the present invention, a coaxial spline drive may also be included in the apparatus 200, which enables washer fastener technology for enhanced bolting safety, precision, and speed. With the Nut, the coaxial spline drive may allow accurate mechanical tensioning. Current sockets, drivers, and apparatus accessories are compatible with the square-drive 276. The square drive 276 may be enclosed by a square drive reaction arm 278 which may be rotated clockwise for tightening of the threaded fasteners and anti-clockwise for the loosening of the threaded fasteners. All reaction fixtures from the product lines are backwards compatible due to the adaptability.

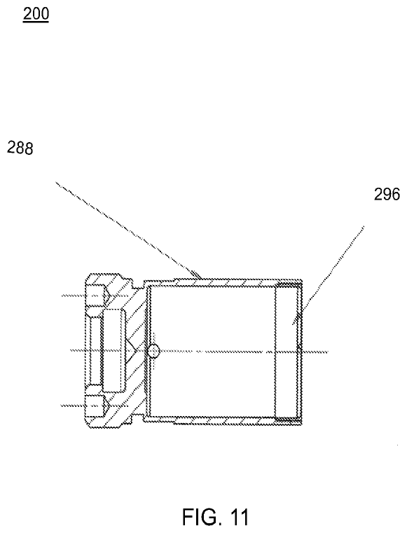

As seen in FIG. 11, the auto-release safety reaction pawl assembly 288 has been employed to improve safety and bolting operations by eliminating the need for the operator to flip a lever to unlock the apparatus when tightening or loosening threaded fasteners. The auto-release safety reaction pawl assembly's 288 integration improves safety and speeds up bolting operations. To remove the apparatus from the operation, the operator does not need to turn a lever. By merely advancing the pump, the apparatus may be able to self-free, making bolting procedures faster, safer, and easier.

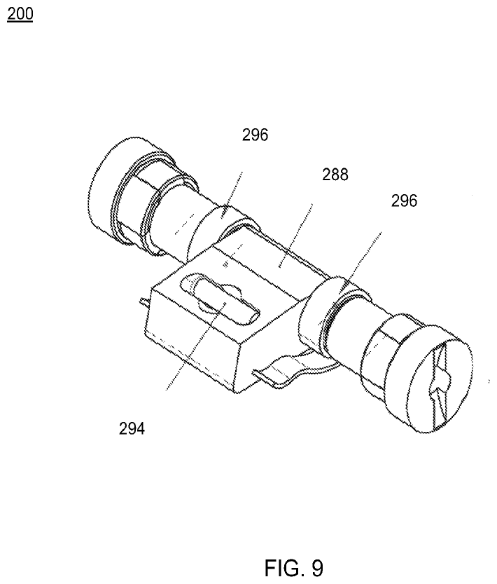

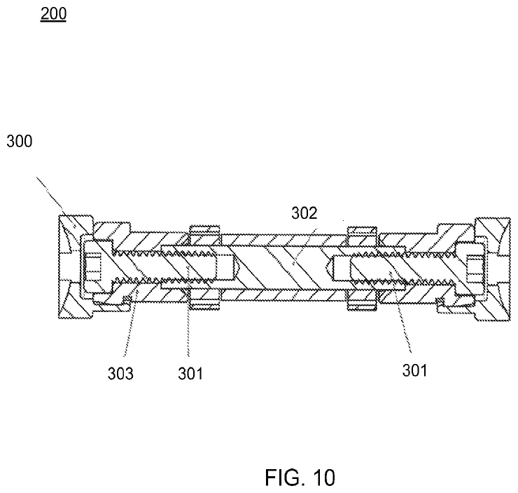

Further, the apparatus 200 may comprise a safety handle installation point 280 for enhancing the security of the apparatus 200 while usage and a drive pawl 295 along with plurality of springs 296a-296n and spring shaft 302, as seen in FIG. 9 and FIG. 10.

The quick-coupler with thread lock assembly has a locking mechanism to prevent accidental disconnection, eliminating the need for the operator to guess when connections are secure. Moreover, the quick-coupler with thread lock assembly provides faster job setup and completion and increased joint integrity.

The cycle counter assembly 282 may be incorporated in the apparatus 200 to track the apparatus 200 usage and allow users to schedule preventative maintenance and calibration.

In an embodiment of the present invention, the employment of the apparatus 200 may be tracked by the incorporated cycle counter assembly 282, which allows users to schedule preventative maintenance and calibration. This feature keeps the tool in peak condition, allowing for precise and reproducible bolting results. The user may extend the life of the apparatus 200 by doing routine preventative maintenance. The cycle counter assembly 282 may comprise counter brackets 297a, and SHCS 297b. The cycle counter 282 may include a sensing device to measure each advance and retract stroke of the piston. Any suitable sensing device may be used, such as, for example, actuating magnets, hall effect, and the like.

The apparatus further comprising an uniswivel fluid assembly 205 that may be configured to inject hydraulic fluid into sleeve 252.

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims.

The foregoing descriptions of specific embodiments of the present disclosure have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the present invention.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements within substantial differences from the literal languages of the claims.

What is claimed is:

1. An apparatus for transmitting torque and tightening or loosening threaded fasteners, the apparatus comprising:
a housing having a driving assembly and a cylinder assembly, a ratchet mechanism being arranged in the driving assembly which is further associated and drivable by the cylinder assembly, wherein the cylinder assembly further comprises:
a piston assembly reciprocating movable along a piston axis; and
an end cap assembly having a safety ring and a hydraulic cylinder assembly, the hydraulic cylinder assembly including:
an end cap at a first end and an opening having an adjacent internally threaded surface at a second end that accepts a piston and threadedly engages with the safety ring, the safety ring being configured to retain a piston of a hydraulically driven torque tool for tightening and/or loosening of threaded fasteners, wherein the safety ring having:
an externally threaded surface; and
an internal surface including a retaining lip at one end which extends inwardly; and
wherein the apparatus further comprises a dual reaction assembly, an auto-release safety reaction pawl assembly, a quick coupler with thread lock assembly and a cycle counter assembly.

2. The apparatus of claim 1, further comprises a ratchet connected with a driving element and the ratchet is turnable about a turning force axis.

3. The apparatus of claim 2, wherein the ratchet receives a first turning force acting about the turning force axis in one direction during operation of the apparatus, further the first turning force turns a deep well hex socket attached to the driving element, which turns a fastener.

4. The apparatus of claim 1, wherein the apparatus further comprising an uniswivel fluid assembly configured to inject hydraulic fluid into sleeve.

5. The apparatus of claim 1, wherein the piston assembly has a first end formed as the piston and a second end is formed as a piston rod.

6. The apparatus of claim 1, wherein the cylinder assembly further includes a plurality of components such as, but not limited to, O-rings, seals, retaining rings, and/or any foregoing combination.

7. The apparatus of claim 1, wherein the end cap assembly further comprises a cylindrical housing defining a coaxial hydraulic cylinder (or sleeve) within.

8. The apparatus of claim 7, wherein the cylindrical housing has an end wall (or cap) at a first end and an opening at a second end that accepts piston.

9. The apparatus of claim 1, wherein the safety ring being threadedly engageable with adjacent opening.

10. The apparatus of claim 9, wherein the adjacent opening of sleeve are internal threads to receive external threads of the safety ring.

11. The apparatus of claim 1, wherein the internal surface of the safety ring is smooth and lines up with an internal surface of sleeve once assembled to allow movement of piston throughout.

12. The apparatus of claim 1, wherein the internal surface including the retaining lip prevent the piston assembly from being separated from the end cap assembly.

13. The apparatus of claim 12, wherein an outer edge of the retaining lip co-terminates with opening when assembled.

14. The apparatus of claim 1, wherein the end cap assembly serves as a hydraulic piston eject safety assembly intended to identify the failure of the apparatus owing to a material fault or overuse/fatigue, which causes the housing to fracture, further portions of the piston assembly, end cap assembly, and/or housing are disengaged from, slip out of, and/or ejected from the apparatus when the housing fractures.

15. The apparatus of claim 1, further comprises a leakage prevention assembly configured to prevent hydraulic fluid from leaking at opening.

16. The apparatus of claim 15, wherein the leakage prevention assembly comprises:
a piston inserted into opening and sleeve;
the safety ring threaded into the sleeve at opening;
the piston rod attached to the piston and the drive assembly, the end cap assembly is attached to the housing;
the O-rings, the seals and/or the retaining rings mounted and sealed cylinder assembly within the housing to prevent hydraulic fluid from leaking at the opening.

17. The apparatus of claim 1, wherein when the apparatus fails, the safety ring prevents the piston from being detached from the end cap assembly by drawing the piston with the end cap assembly, and a component of the drive assembly is suited to grab the piston, preventing and/or substantially slowing any projection thereof.

18. The apparatus of claim 1, wherein the smooth internal surface of the safety ring and a smooth internal surface of the hydraulic cylinder assembly form a sleeve which allows movement of the piston throughout.

19. The apparatus of claim 1, wherein the internally threaded surface at the second end is recessed from the smooth internal surface of the hydraulic cylinder assembly to accept the safety ring such that the smooth internal surface of the safety ring and the smooth internal surface of the hydraulic cylinder assembly form a sleeve which allows movement of the piston throughout.

20. The apparatus of claim 1, wherein the dual reaction assembly is configured to allow the user to configure the apparatus for co-axial and/or rear reaction fixtures.

21. The apparatus of claim 1, wherein the auto-release safety reaction pawl assembly has been employed to improve safety and bolting operations by eliminating the need for the operator to flip a lever to unlock the apparatus when tightening or loosening threaded fasteners.

22. The apparatus of claim 1, wherein the cycle counter assembly is incorporated in the apparatus to track the apparatus usage and allow users to schedule preventative maintenance and calibration.

23. The apparatus of claim 1, wherein the cycle counter assembly includes a sensing device to measure each advance and retract stroke of the piston.

24. The apparatus of claim 1, further comprises a fastener, a socket, a driver and/or one or more reaction fixtures.

25. The apparatus of claim 1, wherein the quick-coupler with thread lock assembly has a locking mechanism to prevent accidental disconnection, eliminating the need for the operator to guess when connections are secure.
